(19) United States
(12) Patent Application Publication
(10) Pub. No.: US 2013/0200795 A1
(43) Pub. Date: Aug. 8, 2013

(54) FOLLOWSPOT AND METHOD FOR RETROFITTING A FOLLOWSPOT

(71) Applicants: Michael L. Clark, Palm Springs, CA (US); Gregory Alan Smith, Leona Valley, CA (US)

(72) Inventors: Michael L. Clark, Palm Springs, CA (US); Gregory Alan Smith, Leona Valley, CA (US)

(21) Appl. No.: 13/366,174

(22) Filed: Feb. 3, 2012

(51) Int. Cl. H01J 61/52; B23P 6/00

(52) U.S. Cl. 315/112; 29/592.1

(57) ABSTRACT

The invention is a followspot and a method for retrofitting an existing followspot, which preferably involves replacing a quartz xenon short arc lamp and separate reflector with a xenon short arc ceramic lamp, which has a built-in reflector. The retrofit of the present invention will provide faster focal length, more light output, and an increased lighting efficiency.

### FIELD OF THE INVENTION

The present invention generally relates to followspots and a method for retrofitting followspots. In particular, the invention is a followspot and a method for retrofitting an existing followspot by replacing a conventional lamp and separate reflector in a lamphouse assembly with an improved lamp that contains a built-in reflector.

### BACKGROUND OF THE INVENTION

For decades, people have been using stage lighting for entertainment purposes, especially in the performing arts such as dance, opera, and theatre. There are a wide variety of stage lighting functions, including: illumination, altering onstage perception, focusing an audience's attention to certain stage areas, and setting a tone of the scene. Consequently, various types of lighting equipment have been used throughout the years to accomplish these functions.

One of the most popular pieces of stage lighting equipment is the followspot (i.e., spot light), which has been utilized for many types of theatrical events. The followspot allows a user or operator to project a bright beam of light onto a performance space to highlight a specific, mobile individual, and typically includes a strong lamp or light source, manually focused lens, a manual device to change the beam's intensity, an “iris” to adjust the size of the beam's spot/angle, and a sighting device to assist the operator in aiming the lamp.

Most conventional followspots, however, lack efficient lighting and focal length capabilities due to having an independent reflector, which is distinct and separate from the lamp/light source. Specifically, a separate reflector causes lighting inefficiencies, which in turn, creates poor focal length ability because, as light spreads within the independent reflector, internal losses occur, which affect the overall light output distribution. In particular, if the light emitted from the lamp and collected by the reflector incidents on any component of the lamp, the light is attenuated, thereby decreasing the output of the lamp. This attenuation can also cause localized heating at the point of incident, which creates high temperatures that will negatively affect the lamp's life span. As such, an improved lamp or light source with a built-in reflector and ceramic body would be ideal to create a higher light output. Currently, there does not exist such a followspot with an improved lamp and no method exists for retrofitting existing followspots with an improved lamp.

Therefore, what is needed is a method of retrofitting a followspot to replace a conventional lamp and independent reflector with an improved lamp with a built-in reflector, wherein the followspot has a faster focal length ability, more light output, and increased lighting efficiency.

### SUMMARY OF THE INVENTION

To minimize the limitations in the prior art, and to minimize other limitations that will become apparent upon reading and understanding the present specification, the present invention discloses a new and useful method for retrofitting a followspot and device thereof.

One embodiment of the present invention is a method for retrofitting a followspot, the steps comprising: providing a followspot; removing one or more covers of a housing of the followspot; disconnecting one or more first wires inside the housing; wherein the one or more first wires includes a first negative wire and a first positive wire; wherein the first negative wire is connected between a negative terminal of a first lamp and a shunt of the housing; wherein the first positive wire is connected between a positive terminal of the first lamp and an igniter assembly; removing the first lamp from the housing; removing a first reflector from the housing; installing a second lamp into the housing; wherein the second lamp includes a second reflector; installing one or more second wires inside the housing; and wherein the one or more second wires includes a second negative wire and a second positive wire; wherein the second negative wire is connected between the negative terminal of the first lamp and the shunt of the housing; wherein the second positive wire is connected between the positive terminal of the first lamp and the igniter assembly; and installing the one or more covers of the housing. Preferably, the second lamp is a ceramic short arc lamp. Preferably, the second lamp includes a heat sink; wherein the heat sink dissipates heat from the second lamp. The second lamp step preferably includes a fan device; wherein the fan device dissipates the heat from the second lamp. Preferably, the installing second lamp step further comprises the step of: installing the fan device by connecting the one or more second wires onto the fan device. Typically, the method for retrofitting a followspot, further comprises the step of: removing a first heat filter from the housing; wherein the first heat filter is substantially near the first reflector. The removing the first lamp step may further comprise the steps of: removing a first interlock device; and installing a second interlock device. Preferably, the removing first lamp step further comprises the step of: removing a dowser assembly. The method for retrofitting a followspot may further comprise the step of: installing a second heat filter into the housing. The second lamp typically includes one or more springs; wherein the one or more springs provide a tilting capability of the second lamp. Typically, the method further comprises the step of: installing a power supply into the followspot; wherein the power supply provides electrical power to the followspot. Typically, the second lamp provides a faster focal length; an increased light output; and an increased lighting efficiency.

Another embodiment of the present invention is a method for retrofitting a followspot, the steps comprising: providing a followspot; removing one or more covers of a housing of the followspot; disconnecting one or more first wires inside the housing; wherein the one or more first wires includes a first negative wire and a first positive wire; wherein the first negative wire is connected between a negative terminal of a first lamp and a shunt of the housing; wherein the first positive wire is connected between a positive terminal of the first lamp and an igniter assembly; removing the first lamp from the housing; removing a first reflector from the housing; installing a second lamp into the housing; wherein the second lamp includes a second reflector; wherein the second lamp provides a faster focal length; an increased light output; and an increased lighting efficiency; installing one or more second wires inside the housing; wherein the one or more second wires includes a second negative wire and a second positive wire; wherein the second negative wire is connected between the negative terminal of the first lamp and the shunt of the housing; wherein the second positive wire is connected between the positive terminal of the first lamp and the igniter assembly; installing the one or more covers of the housing; and installing a power supply into the followspot; wherein the power supply provides electrical power to the followspot. Preferably, the second lamp is a ceramic short arc lamp. Preferably, the second lamp includes a heat sink; wherein the heat sink dissipates heat from the second lamp. The second lamp step typically includes a fan device; wherein the fan device dissipates heat from the second lamp. Preferably the installing second lamp step further comprises the step of: installing the fan device by connecting the one or more second wires onto the fan device. Preferably, the method for retrofitting a followspot, further comprises the step of: removing a first heat filter from the housing; wherein the first heat filter is substantially near the first reflector. Typically, the removing the first lamp step further comprises the steps of: removing a first interlock device; and installing a second interlock device.

Another embodiment of the present invention is a followspot, comprising: a housing; a lamp; a lens; and a power supply. The lamp is a ceramic short arc lamp. The lamp is located substantially inside the housing of a followspot. The lamp provides a light. The lamp includes a reflector; a heat filter; and a heat sink; wherein the reflector reflects the light. The heat filter is substantially inside of the housing; wherein the heat filter absorbs radiation from the light. The heat sink dissipates heat from the lamp, and the lens is located substantially inside the housing. The lens provides a focus of the light of the followspot. The power supply provides electrical power to the followspot. The lamp provides a faster focal length; an increased light output; and an increased lighting efficiency.

It is an object of the invention to retrofit an existing followspot that uses a short arc lamp and a separate reflector, with a short arc ceramic lamp which incorporates a built-in reflector. The ceramic lamp that will replace the short arc lamp has a faster focal length ability than the conventional xenon short arc lamp and reflector assembly, which usually has a focal speed of 2 or greater. The faster focal speed of the ceramic lamp allows the user to obtain a smaller spot image with the same spot to flood ratio as the present short arc xenon reflector and lamp system and will produce 70% greater light output at the same distance as the conventional system.

It is an object of the present invention to provide a retrofit that modifies an existing followspot to create: (1) faster focal length ability; (2) more light output; and (3) increased lighting efficiency.

It is an object of the invention to use the device with an integrated reflector and electrodes comprised of an insulator between anode and cathode and filled with a gas, typically xenon for the stage lighting industry, which is the market where a system is used to project a light onto a performer or used for general effect lighting in a theatre, coliseum, traveling show, television set, or motion picture set. The system can be fixed, manually moveable, or automatically moved by the use of some form of robotic automation system.

It is an object of the present invention to provide more light output to be projected through the aperture and onto the object that is needed to be illuminated. The incorporation of the improved ceramic lamp with reflector into a followspot system will allow a reduction in image size over the present standard lamp and independent reflector combination due to the fast focal length of the ceramic lamp. The faster focal length allows an image to be projected at a greater distance with more light intensity because conventional followspots require a larger reflector to collect the light due to the size of the standard quartz xenon lamp.

It is an object of the present invention to replace a separate reflector and lamp assembly in an existing light fixture with a new system and lamp replacement system, which will provide a more compact device. The new lamp will be more efficient or “green” because the retrofitted system requires less power due to the increased efficiency of the lamp and because the improved light source can be disposed of safely and in a more environmentally friendly manner after a passive depressurization of the lamp. The lamp will be safer and easier to install in the field and the cooling requirements will be less than is needed before the retrofit.

It is an object of the present invention to overcome the limitations of the prior art.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is an illustration of a perspective view of one embodiment of a followspot before implementation of the retrofitting method.

FIG. 2 is an illustration of a top-perspective view of the lamphouse assembly of one embodiment of a followspot before implementation of the retrofitting method.

FIG. 3 is a schematic illustration of one embodiment of a followspot lamp before implementation of the retrofitting method and shows the electrical connection between the igniter assembly and lamp.

FIG. 4 is an illustration of one embodiment of a followspot and shows the inner electrical connections of the lamphouse assembly without the first lamp during implementation of the retrofitting method of the present invention.

FIG. 5 is an illustration of a perspective view of the second lamp of one embodiment of the followspot and shows the second lamp with a heat sink and fan assembly.

FIG. 6 is an illustration of a rear view of the second lamp of one embodiment of the followspot and shows the second lamp with a heat sink and fan assembly.

FIG. 7 is an illustration of a side view of one embodiment of the followspot without the top cover and shows the second lamp installed inside the lamphouse.

FIG. 8 is a block diagram of one embodiment of the retrofitting method for a followspot.

### DETAILED DESCRIPTION OF THE DRAWINGS

In the following detailed description of various embodiments of the invention, numerous specific details are set forth in order to provide a thorough understanding of various aspects of one or more embodiments of the invention. However, one or more embodiments of the invention may be practiced without some or all of these specific details. In other instances, well-known methods, procedures, and/or components have not been described in detail so as not to unnecessarily obscure aspects of embodiments of the invention.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the screen shot figures, and the detailed descriptions thereof, are to be regarded as illustrative in nature and not restrictive. Also, the reference or non-reference to a particular embodiment of the invention shall not be interpreted to limit the scope of the invention.

In the following description, certain terminology is used to describe certain features of one or more embodiments of the invention. For instance, the term “lamp”, “lamp source”, “light”, and/or “light source” refers to any device that generates light for lighting equipment, including without limitation, gas discharge lamps, short arc lamps, long arc lamps, xenon lamps, xenon arc lamps, pulsed xenon lamps, incandescent, halogen, fluorescent, compact fluorescent lamps, high-intensity discharge lamps, low-pressure sodium lamps, and light emitting diodes. The term “followspot” refers to any device which projects a bright beam of light onto a performance space, including without limitation, spot lights, floodlights, parabolic aluminized reflector lights, strip lights, scoop lights, light emitting diode stage lights, fresnels, and ellipsoidal reflectors.

The retrofit method of the followspot device proposed by the present invention modifies high-performance lighting equipment by replacing a conventional lamp or light source and the separate reflector with an improved lamp or light source with a built-in reflector. Preferably, the new lamp is a xenon short arc ceramic lamp, which replaces a conventional xenon short arc lamp. Modifying the lighting fixture with the new lamp should allow the followspot device to have: (1) a faster focal length; (2) at least 70% more light output than the conventional lamp; and (3) increased lighting efficiency, such that the new lamp provides more light output and less light attenuation. The new lamp should also be easier and cleaner to dispose.

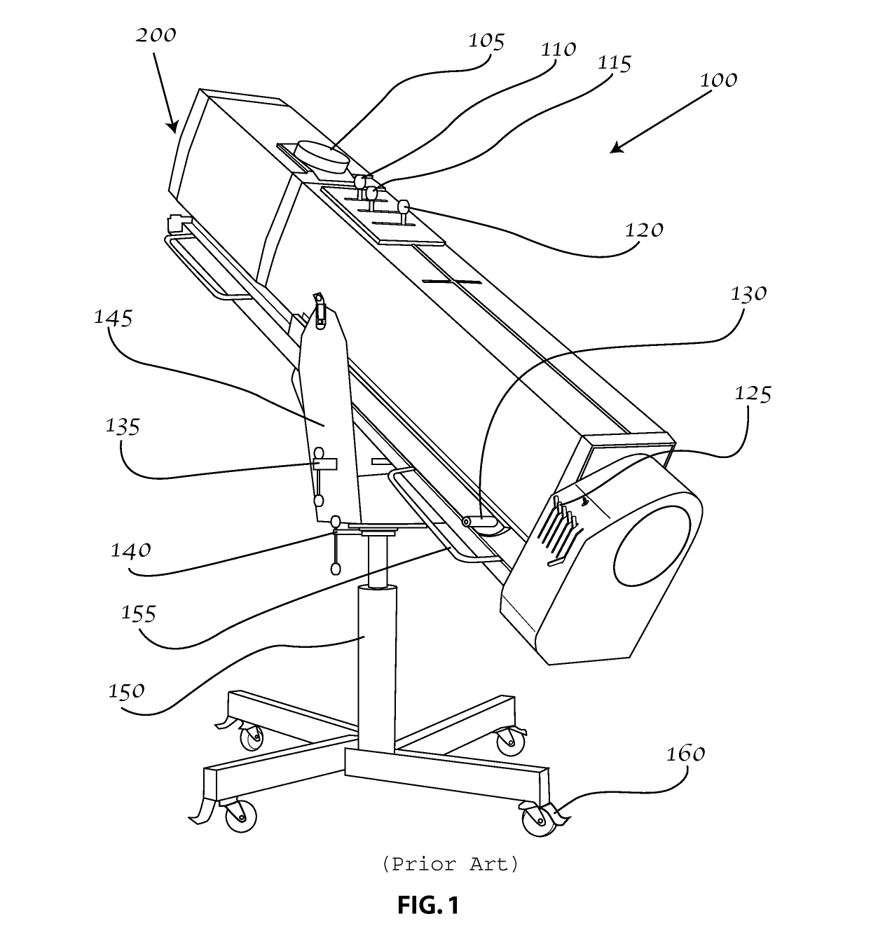

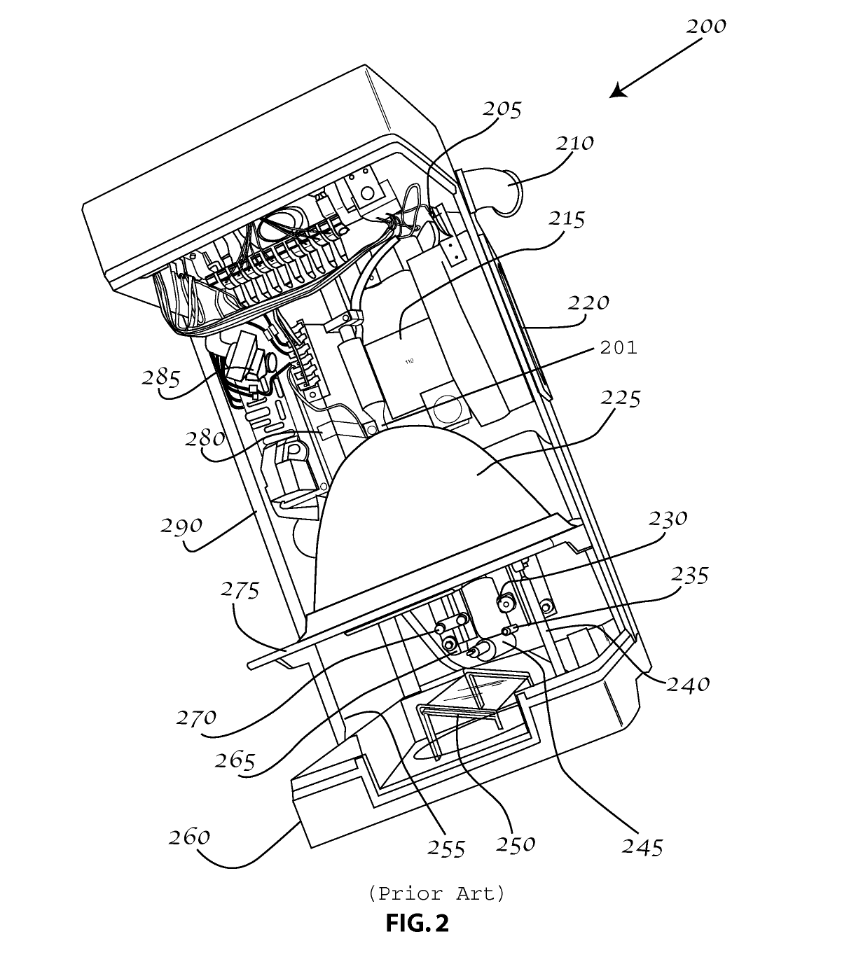

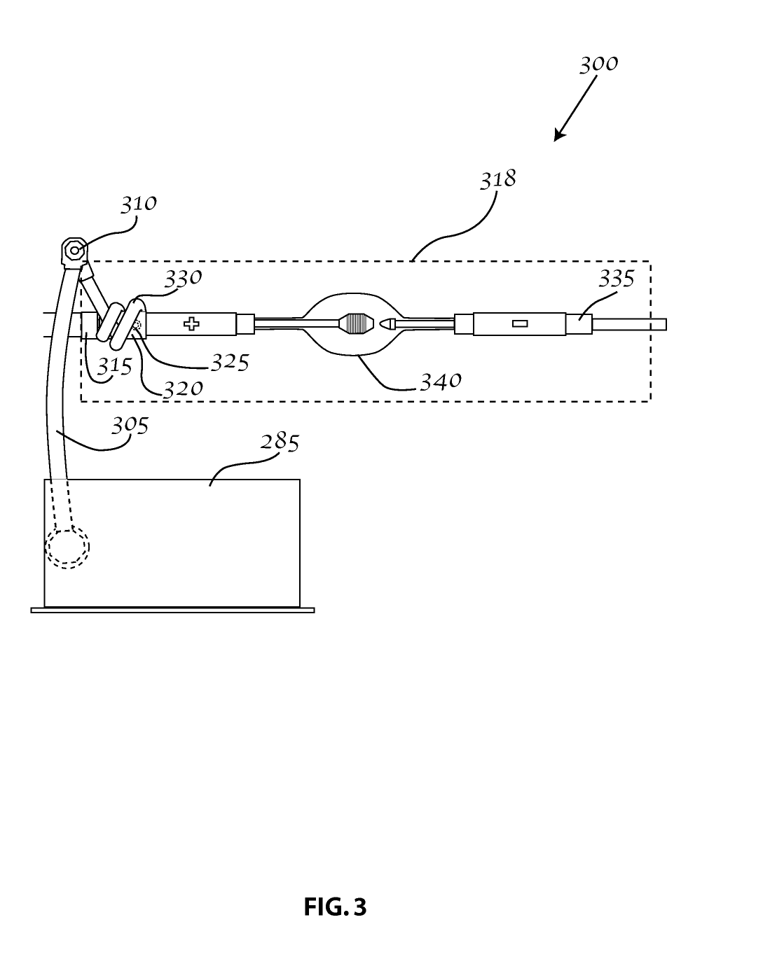

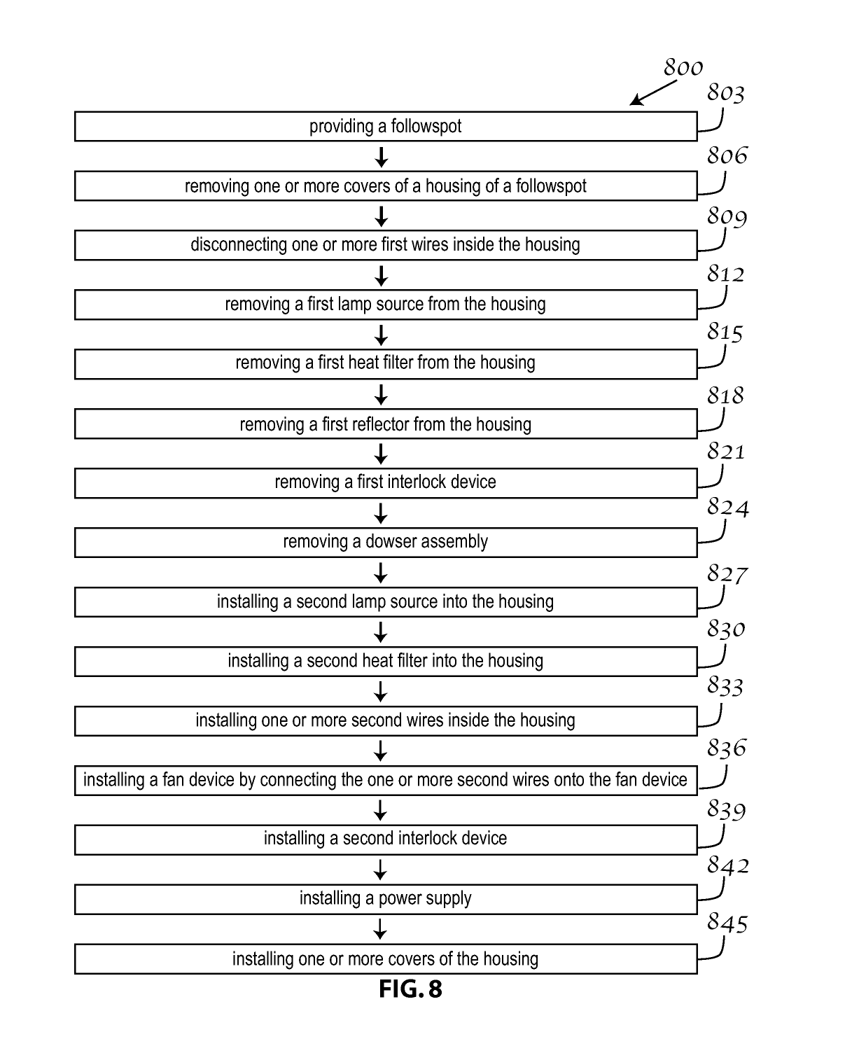

FIG. 1 is an illustration of a perspective view of one embodiment of a followspot before implementation of the retrofitting method. FIG. 1 is marked as prior art because it shows a followspot before it has been retrofitted. As shown in FIG. 1, the followspot 100 configured for the retrofitting method 800 (as shown in FIG. 8) preferably includes: a fan/vent 105; dowser assembly 110; damper 115; iris 120; boomerang 125; focus knob/handle 130; tilt adjustment 135; pan adjustment 140; yoke 145; base 150; movement handle 155; leveling jacks 160 and lamphouse assembly 200. The followspot 100 configured for the retrofitting method 600 may also include other devices such as an external power supply and ballast without deviating from the scope of the invention. The fan/vent 105 is preferably a ventilation fan that cools the lamp, which operates at a very high temperature. The dowser assembly 110 is generally a device mechanism that allows a user to mechanically “dim” the emitted light of the followspot 100, and is usually a handle on the back or side of the followspot 100. The damper 115 (also known as the chopper or shutter) is typically constructed as two shutters that chop the light up and down. The iris 120 is typically a mechanism that makes the circle of light smaller or bigger as required. Generally, the boomerang 125 is the section either located at the right, front, or middle of the followspot that has six or more handles for color filters; wherein the handles pull down and click the filters into place. The focus knob/handle 130 is the knob or handle that adjust the first reflector 225 (shown in FIGS. 2 and 3) to provide a sharp or soft focus. The tilt adjustment 135 is typically an adjustment knob that allows the followspot to move up and down, and is typically found on the yoke 145. The pan adjustment 140 is generally an adjustment that allows the followspot 100 to swivel left and right, and is usually found on the base 150. Like other traditional lighting fixtures, the yoke 145 is typically the “U-shaped” structure that is directly connected to the fixture. The base 150, which may be a separate component of the followspot, is preferably the structure that supports the unit by connecting to the yoke 145, and most often includes casters. The movement handle 155 is generally the handles (typically in the back and side of the followspot 100), that allow either up-down and/or right-left movements of the followspot 100. Generally, the leveling jacks 160 are components that allow the followspot to be lifted off the base's castors and provide fine leveling adjustments.

FIG. 2 is an illustration of a top-perspective view of the lamphouse assembly of one embodiment of a followspot before implementation of the retrofitting method. As shown in FIG. 2, the lamphouse assembly 200 preferably includes: lamp 201; an airflow switch 205; cable connector 210; blower 215; blower intake grille 220; first reflector 225; insulator bushing 230; cathode lead connector stud 235; tie rod 240; air duct 245; heat filter 250; inner heat shield 255; front casting 260; contact and clamp 265; cathode shock mount assembly 270; reflector support casting 275; igniter hold-down strap 280; igniter assembly 285; and housing 290. FIG. 2 shows how the lamp 201 and reflector 225 are not integrated into a singular unit. The airflow switch 205 is generally located at the rear lamphouse blower and typically prevents operation of the xenon lamp if the blower 215 is not operating, or if the airflow is inadequate. The cable connector 210 typically connects to an external power supply and generally provides power to the lamphouse assembly 200. The blower 215 is usually internally wired in the lamphouse, typically operates on 115 VAC, and is generally required to keep the seals on the lamp at a safe operating temperature. The blower 215 should operate continuously until the power is turned off at the main line switch to the power supply. The blower intake grille 220 preferably provides ventilation for the blower 215 to emit air from the lamphouse assembly 200. The first reflector 225 is typically constructed as a deep ellipse dichroic metal and is preferably designed to operate in a fixed position with a horizontally mounted xenon bulb as the light source. Although the FIG. 2 shows the first reflector 225 made of metal, the present invention allows the reflector to be made of any manmade metal or nonmetal such as ceramic, alumina, copper, nickel, brass, chromium, silver without deviating from the scope of the invention. Additionally, the first reflector 225 may be formed as a parabola, ellipse, aconic or other computer generated curves. The insulator bushing 230 is preferably used to protect the voltage cables from damage caused by any sharp edges. Preferably, the cathode lead connector stud 235 provides contact with the cathode portion of a lamp. The tie rod 240 is usually located at the upper corner of the lamphouse, and typically allows the user to reposition the first reflector 225. The air duct 245 preferably provides ventilation of the lamphouse assembly 200. The heat filter 250 is typically located in the front of the lamphouse and should reduce heat at the optical system and color boomerang. The inner heat shield 255 is typically located adjacent between the heat filter 250 and first reflector 225, and is typically designed to assist in absorbing excessive heat in the lamphouse assembly 200. The front casting 260 is generally designed to provide frontal support of the lamphouse assembly 200. The contact and clamp 265 usually provides electrical contact at the negative lamphouse lead. The cathode shock mount assembly 270 preferably mounts the cathode portion of the lamp. Preferably, the reflector support casting 275 should provide support to the first reflector 225, especially in adjusting the first reflector 225 with the tie rod 240. The igniter hold-down strap 280 is preferably a metal strap that secures the igniter assembly 285. The igniter assembly 285 is preferably used to “ignite” the lamps, which are typically discharge lamps. The housing 290 preferably provides an enclosure for the lamphouse components. Because discharge lamps usually operate with gases such as neon, argon, or xenon, a very high voltage is required to strike the arc by touching and separating the electrodes in order to ignite the lamp.

In some cases, the first reflector 225 and first lamp or light source 201/300 are assembled together and optically aligned to maximize the output of the assembly of the first lamp 201/300 and first reflector 225 are then sealed together using an epoxy material or cement to prevent movement of the assembly. In other cases, the first reflector 225 and first lamp 201/300 are configured for manual alignment of the assembly to optimize the output of the assembly.

FIG. 3 is a schematic illustration of one embodiment of a followspot lamp before implementation of the retrofitting method and shows the electrical connection between the igniter assembly and lamp. As shown in FIG. 3, the electrical connection between the igniter assembly and first lamp 300 preferably includes: an igniter assembly 285; first positive wire 305; hexnut 310; clamp 315; and first lamp 318. Preferably, the first lamp 318 includes: an cathode adapter 320; set screw 325; bulb anode lead 330; anode adapter 335; and bulb 340, and typically uses various types such as metal halide, tungsten halogen, and mercury. The first positive wire 305 is preferably the igniter output positive lead wire, which provides an electrical connection between the igniter assembly 285 and first lamp 318. The hexnut 310 preferably secures a terminal of the first positive wire 305. Preferably, the clamp 315 secures the cathode adapter 320 of the bulb 340, and the bulb cathode lead 330 preferably wraps around the cathode adapter 320 into place using a set screw 325. The anode adapter 335 is typically configured to provide a connection for the cathode portion of the bulb 340.

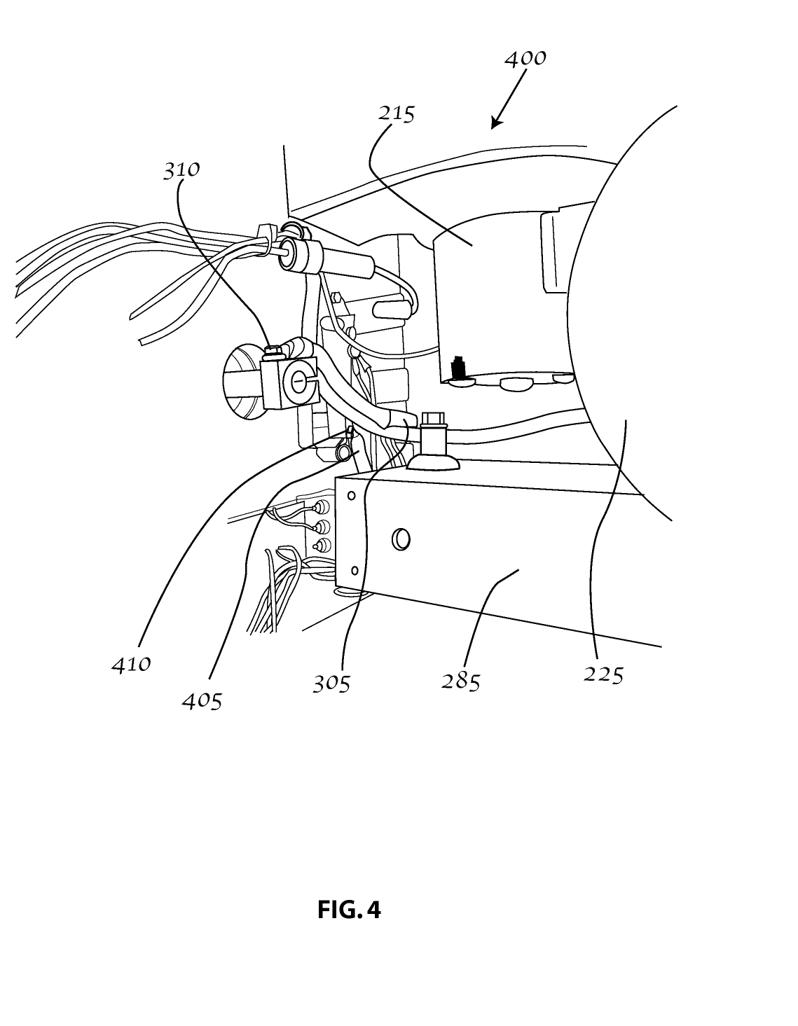

FIG. 4 is an illustration of one embodiment of a followspot and shows the inner electrical connections of the lamphouse assembly without the first lamp during implementation of the retrofitting method of the present invention. FIG. 4 shows the blower 215; first reflector 225; igniter assembly 285; first positive wire 305; hexnut 310; first negative wire 405; and shunt 410. Preferably, the first negative wire 405 provides an electrical connection between the anode adapter 335 of the bulb 340 and the shunt 410, which is typically located at the rear end of the lamphouse assembly 200, as shown in FIG. 4.

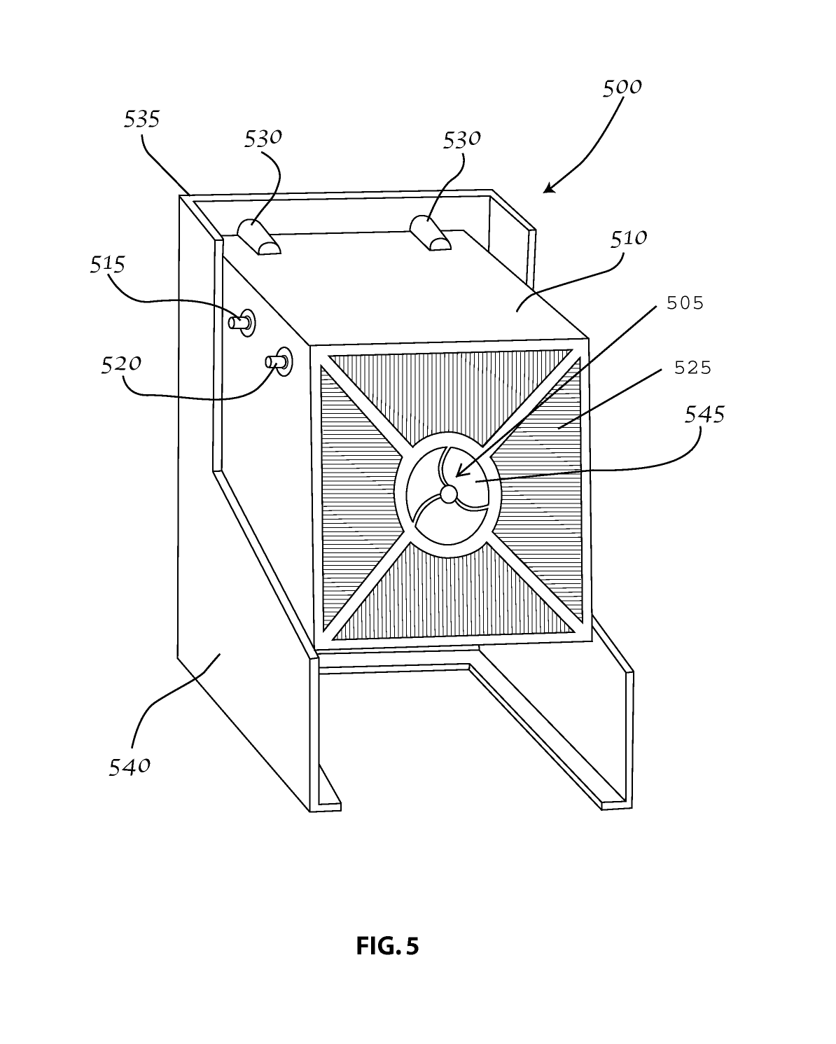

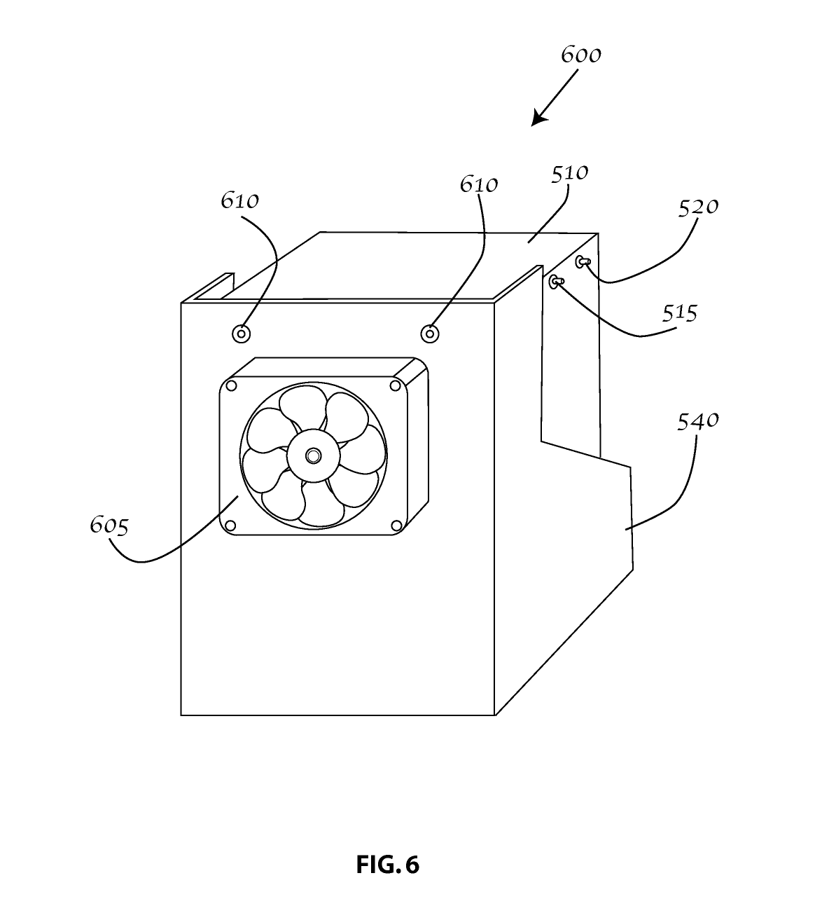

FIG. 5 is an illustration of a perspective view of the second lamp of one embodiment of the followspot and shows the second lamp with a heat sink and fan assembly. As shown in FIG. 5, the second lamp 500 preferably includes a xenon short arc ceramic lamp 505; housing 510; positive lead connection 515; negative lead connection 520; heat sink 525; springs 530; and fan assembly 535. The xenon short arc ceramic lamp 505 provides a greater light output than the first lamp 318 and preferably includes a second reflector 545 built into the second lamp 500. The xenon short arc ceramic lamp 505 also typically includes tungsten electrodes, which are also integrated into the second lamp 500; an insulator, which should be capable of withstanding 40 kv; and gas, which is typically xenon at a pressure usually greater than 250 psi. Although FIG. 5 shows a xenon short arc ceramic lamp 505, it should be understood that the present invention allows the use of any lamp devices such as metal halide, tungsten halogen, and mercury. The housing 510 preferably encloses the xenon short arc ceramic lamp 505 and preferably includes the heat sink 525, which cools the second lamp 500 by dissipating heat. The positive lead connection 515 should provide an electrical connection for the cathode portion of the second lamp 500. The negative lead connection 520, on the other hand, should provide an electrical connection for the anode portion of the second lamp 500. The springs 530 should be adjustable and should provide tilting of the second lamp 500. While only two springs 530 are shown in FIG. 5, it should be understood that the present invention may allow any number of springs without deviating from the scope of the invention. The fan assembly 535 preferably includes a fan 605 (shown in FIG. 6) and a fan fixture adapter 540; wherein the fan assists the heat sink 525 in dissipating heat from the second lamp 500 by removing heated air from the heat sink, and the fan fixture adapter 540 should secure the second lamp 500 onto the followspot 100.

The second lamp 500 preferably has a faster focal length ability than the conventional xenon short arc lamp and reflector assembly, and the second lamp 500 usually has a focal speed of 2 or greater. The faster focal speed of the ceramic lamp should allow the user to obtain a smaller spot image with the same spot to flood ratio as the present short arc xenon reflector and lamp system and should produce 70% greater light output at the same distance as the conventional system. However, the present invention should produce any increase of focal length ability, light output, and lighting efficiency without deviating from the scope of the invention.

FIG. 6 is an illustration of a rear view of the second lamp of one embodiment of the followspot and shows the second lamp with a heat sink and fan assembly. As shown in FIG. 6, the second lamp 500 preferably includes the fan assembly 535, which includes a fan 605 and fan fixture adapter 540, and adjustment screws 610. As mentioned earlier, the fan 605 should increase the dissipation of heat from the second lamp 500 by removing heated air from the heat sink 525. The adjustment screws 610 preferably provide an adjustment of the springs 530 to tilt the housing 510 of the second lamp 500.

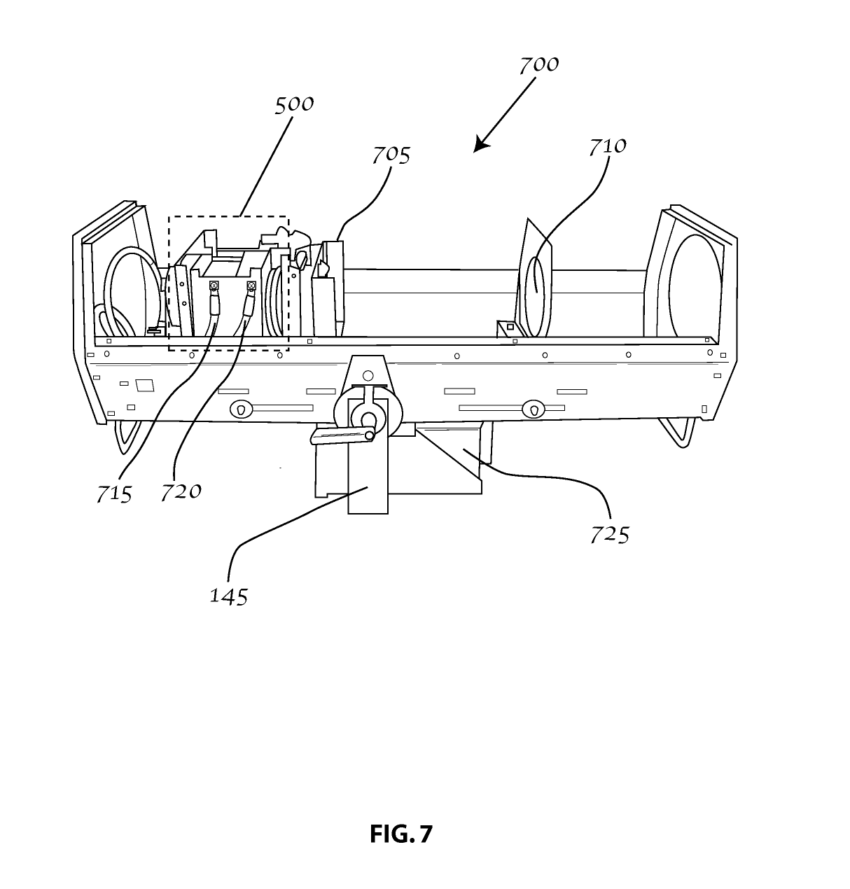

FIG. 7. is an illustration of a side view of one embodiment of the followspot without the top cover and shows the second lamp installed inside the lamphouse. As shown in FIG. 7, the followspot 700 without the top cover preferably includes: a yoke 145; second lamp 500; aperture assembly 705 (also called aperture and special effects assembly); large lens 710; second positive lead wire 715; second negative lead wire 720; and independent and self contained power supply assembly 725. Preferably, the second lamp 500 is electrically connected to both the second positive lead wire 715 for the cathode portion of the lamp and second negative lead wire 720 for the anode portion of the lamp. Unlike conventional followspots that utilize an external power supply, the present invention may incorporate an internal power supply assembly 725, which is any power supply source that is incorporated into the followspot 100 without deviating from the scope of the invention. The large lens 710 is typically any type of lens used for focusing the light beam through the followspot 500 and can be constructed with varying thicknesses. The large lens 710 also is usually made of sapphire, but can also be made of other materials as well such as quartz. The large lens 710 is also usually coated to prevent the transmission of ozone producing ultraviolet light. Although FIG. 7 shows the a followspot as one that has been retrofitted, but it should be understood that the followspot may be made using second lamp 500 from the outset.

FIG. 8 is a block diagram of one embodiment of the method for retrofitting a followspot. As shown in FIG. 8, the retrofit method 800 preferably, comprises the steps of: providing a followspot 803; removing one or more covers of a housing of the followspot 806; disconnecting one or more first wires inside the housing 809; removing a first lamp from the housing 812; removing a first heat filter from the housing 815; removing a first interlock device 818; removing a first reflector from the housing 821; removing a dowser assembly 824; installing a second lamp into the housing 827; installing a second heat filter into the housing 830; installing one or more second wires inside the housing 833; installing a fan device by connecting the one or more second wires onto the fan device 836; installing a second interlock device 839; installing a power supply 842; and installing the one or more covers of the housing 845. It should be understood that the retrofit method 800 may also include other steps and may be performed in any sequence without deviating from the scope of the invention.

FIG. 8 shows the first step of the retrofit method 800, which is providing a followspot 803. A user preferably acquires a conventional followspot 100, for retrofitting a conventional lamp. The present invention, however, allows a user to acquire any type of lighting equipment such as spot lights, floodlights, parabolic aluminized reflector lights, strip lights, scoop lights, light emitting diode stage lights, fresnels, and ellipsoidal reflectors without deviating from the scope of the invention.

FIG. 8 also shows the second step of the retrofit method 800, which is removing one or more covers of a housing of the followspot 806. Generally, after the user acquires a followspot 100 or lighting device, the user will need to access the internal components and certain wires. The step will allow the user to disconnect certain wires such as the first positive wire 305 and/or the first negative wire 405. Additionally, this step also allows the user to remove certain components such as the first lamp 300, heat filter 250, first reflector 225; and dowser assembly 110. Thus, this step may entail removing different covers such as the lamphouse cover, and the front optical cover.

FIG. 8 shows the next six steps of the retrofit method 800, which involve disconnecting and removing components. Specifically, the next six steps are: disconnecting one or more first wires inside the housing 809; removing a first lamp from the housing 812; removing a first heat filter from the housing 815; removing a first interlock device 818; removing a first reflector from the housing 821; and removing a dowser assembly 824. After removing the covers of the followspot 100, the user should have access to the followspot's primary internal components as well as the wiring. It should be understood that the present invention allows these six steps to be performed in any sequence without deviating from the scope of the invention.

Regarding the third step, disconnecting one or more wires inside the housing 809; the user should first disconnect the first negative wire 405 between the housing 290 and first lamp 300. This may specifically involve the user to disconnect and remove the first negative wire 405 between a shunt 410 and cathode adapter 335. The user should also disconnect the first positive wire 305, which is typically connected between the igniter and lamp adapter. Preferably, disconnecting the first positive wire 305 should be performed after the user has performed steps four through seven—i.e., removing the first lamp from the housing 812; removing a first heat filter from the housing 815; removing a first interlock device 818, and removing a first reflector from the housing 821.

Regarding the fourth step, removing a first lamp from the housing 812, the user preferably removes a conventional lamp device from the housing. Generally, the followspot 100 contains high-intensity discharge lamps such as quartz xenon short arc lamps, which are typically constructed out of fused quartz or fused alumina arc tube. It should be understood, however, that the present invention allows the user to remove other types of lamps as well, including without limitation, gas discharge lamps, short arc lamps, long arc lamps, xenon lamps, xenon arc lamps, pulsed xenon lamps, incandescent, halogen, fluorescent, compact fluorescent lamps, high-intensity discharge lamps, low-pressure sodium lamps, and light emitting diodes.

The fifth step, removing a first heat filter from the housing 815, requires a user to remove the heat filter 250 that is enclosed in the housing 290. As mentioned above, a conventional followspot 100, has a heat filter 250 typically located in the front of the lamphouse and should reduce heat at the optical system and color boomerang. The user typically removes the heat filter 250 and may either dispose the heat filter 250 or generally reapply the heat filter 250 after installation of the second lamp 500. Although the heat filter 250 is typically positioned immediately in front of the first reflector 225, it should be understood that the user may remove the heat filter 250 from any location of the housing 290 without deviating from the scope of the invention.

FIG. 8 shows the sixth and seventh steps of the retrofit method 800—i.e., removing a first reflector from the housing 818 and removing a first interlock device 821. In the sixth step, the user preferably uninstalls the first reflector 225, which may require removing the tie rod 240 and any other associated washers and/or screws. Although the FIG. 2 only shows one tie rod 240, it should be understood that the present invention allows the removal of other tie rods as well without deviating from the scope of the invention.

FIG. 8 shows the seventh step of the retrofit method 800, which is removing a first interlock device 821. Generally, the interlock device is a safety device which disables the electrical function of the followspot. The primary purpose for this step is usually for the installation of a second interlock device, which is typically needed to adjust the new voltage and/or wattage settings of the second lamp 500.

FIG. 8 shows the eighth step of the retrofit method 800, which is removing a dowser assembly 824. As mentioned above, the dowser assembly 110 is generally a device mechanism that allows a user to mechanically “dim” the emitted light of the followspot 100, and is usually located in front of the lamphouse assembly 200. Although not necessary, the present invention allows the user to reinstall the dowser assembly 110 after installation of the second lamp 500.

FIG. 8 shows the next seven steps of the retrofit method 800, which are steps for installing several components into the followspot 100. Specifically, the steps nine to fifteen are: installing a second lamp into the housing 827; installing a second heat filter into the housing 830; installing one or more second wires inside the housing 833; installing a fan device by connecting the one or more second wires onto the fan device 836; installing a second interlock device 839; installing a power supply 842; and installing the one or more covers of the housing 845.

Regarding installing the second lamp into the housing 827, this step typically involves installing a xenon short arc ceramic lamp 505 which includes screwing or fitting the housing 510 and heat sink 525 into the lamphouse assembly 200. It should be understood this step allows for the adjustment of the springs 530 to tilt the second lamp 500 for adjusting the light beam of the followspot 100.

Regarding installing a second heat filter into the housing 830, the second heat filter is typically installed in front of a lens, which is typically the condenser lens of the followspot 100. Although the second heat filter may be different from the first heat filter 250, it should be understood that the present invention allows the second heat filter to be the same as the first heat filter. It should also be understood that the present invention allows the installation of the second heat filter in any portion of the followspot device.

FIG. 8 shows the eleventh step of the method 800, which is installing one or more second wires inside the housing 833. This step preferably entails installing the second positive wire 715 and second negative wire 720 to the second lamp 500. Specifically, the second negative wire 720 should couple to the negative lead connection 520 of the second lamp 500 and into the shunt 410 of the lamphouse assembly 200. The second positive wire 715, on the other hand, should couple to the positive lead connection 515 of the second lamp 500 and into the igniter assembly 285. It should be understood, however, that the present invention allows the second positive wire 715 and second negative wire 720 to be reconnected to other terminals of the lamphouse assembly 200 as well without deviating from the scope of the invention.

FIG. 8 shows the twelfth step, which is installing one or more second wires inside the housing 833. This typically includes installing lead wires between the fan assembly 535 of the second lamp 500 and between a power supply assembly 725. The present invention allows the installation of the one or more wires to also be between other parts of the lamphouse assembly 200 as well without deviating from the scope of the invention.

FIG. 8 shows the thirteenth step—i.e., installing a second interlock device 839. This step preferably requires installing the second interlock device on the lower portion of the lamphouse assembly 200, and should include the proper electrical settings for the second lamp 500.

FIG. 8 shows the fourteenth step, which is installing a power supply 842. Currently, followspots do not include a power supply built into the followspot 100 and must be connected to an external power supply. As such, the present invention allows the user to incorporate an existing power supply into the followspot 100. The power supply assemblies used for the present invention are any power supply sources that are known in the art. Preferably, the power supply 842 will be attached to the lower portion of the followspot 100 but may be attached in any location as well without deviating from the scope of the invention. The power supply typically will have an input alternating current potential between 100VAC and 240VAC, with an operating frequency of 50 to 60 hertz. The power supply may supply an open circuit of no load voltage of 150 to 200Vdc to an ignition assembly and the no load voltage will charge a circuit in the igniter assembly between 25 and 35 kilovolts; wherein the voltage produced by the igniter assembly is used to “ignite” or breakdown the gases between the electrodes.

FIG. 8 shows the fifteenth step of the retrofit method 800, which installing the one or more covers of the housing 845. This step typically involves installing the front cover housing of the followspot 100, and the cover for the lamphouse assembly 200. Preferably, this step is performed after the user installs the second lamp 500, heat filter 250, wires, and other components.

Unless otherwise stated, all measurements, values, ratings, positions, magnitudes, sizes, locations, and other specifications which are set forth in this specification, including in the claims which follow, are approximate, not exact. They are intended to have a reasonable range which is consistent with the functions to which they relate and with what is customary in the art to which they pertain.

The foregoing description of the preferred embodiment of the invention has been presented for the purposes of illustration and description. While multiple embodiments are disclosed, still other embodiments of the present invention will become apparent to those skilled in the art from the above detailed description, which shows and describes illustrative embodiments of the invention. As will be realized, the invention is capable of modifications in various obvious aspects, all without departing from the spirit and scope of the present invention. Accordingly, the detailed description is to be regarded as illustrative in nature and not restrictive. Also, although not explicitly recited, one or more embodiments of the invention may be practiced in combination or conjunction with one another. Furthermore, the reference or non-reference to a particular embodiment of the invention shall not be interpreted to limit the scope the invention. It is intended that the scope of the invention not be limited by this detailed description, but by the claims and the equivalents to the claims that are appended hereto.

Except as stated immediately above, nothing which has been stated or illustrated is intended or should be interpreted to cause a dedication of any component, step, feature, object, benefit, advantage, or equivalent to the public, regardless of whether it is or is not recited in the claims.

What is claimed is:

1. A method for retrofitting a followspot, the steps comprising:
providing a followspot;
removing one or more covers of a housing of said followspot;
disconnecting one or more first wires inside said housing;
wherein said one or more first wires includes a first negative wire and a first positive wire;
wherein said first negative wire is connected between a negative terminal of a first lamp and a shunt of said housing;
wherein said first positive wire is connected between a positive terminal of said first lamp and an igniter assembly;
removing said first lamp from said housing;
removing a first reflector from said housing;
installing a second lamp into said housing;
wherein said second lamp includes a second reflector;
installing one or more second wires inside said housing; and
wherein said one or more second wires includes a second negative wire and a second positive wire;
wherein said second negative wire is connected between said negative terminal of said first lamp and said shunt of said housing;
wherein said second positive wire is connected between said positive terminal of said first lamp and said igniter assembly;
installing said one or more covers of said housing.

2. The method for retrofitting a followspot in claim 1, wherein said second lamp is a ceramic short arc lamp.

3. The method for retrofitting a followspot in claim 2, wherein said second lamp includes a heat sink;
wherein said heat sink dissipates heat from said second lamp.

4. The method for retrofitting a followspot in claim 3, wherein said second lamp step includes a fan device;
wherein said fan device dissipates heat from said second lamp.

5. The method for retrofitting a followspot in claim 4, wherein said installing second lamp step further comprises the step of:
installing said fan device by connecting said one or more second wires onto said fan device.

6. The method for retrofitting a followspot in claim 5, further comprising the step of:
removing a first heat filter from said housing;
wherein said first heat filter is substantially near said first reflector.

7. The method for retrofitting a followspot in claim 6, wherein said removing said first lamp step further comprises the steps of:
removing a first interlock device; and
installing a second interlock device.

8. The method for retrofitting a followspot in claim 7, wherein said removing first lamp step further comprises the step of:
removing a dowser assembly.

9. The method for retrofitting a followspot in claim 8, further comprising the step of:
installing a second heat filter into said housing.

10. The method for retrofitting a followspot in claim 9, wherein second lamp includes one or more springs;
wherein said one or more springs provide a tilting capability of said second lamp.

11. The method for retrofitting a followspot in claim 10, wherein said method further comprises the step of:
installing a power supply into said followspot;
wherein said power supply provides electrical power to said followspot.

12. The method for retrofitting a followspot in claim 11, wherein said second lamp provides a faster focal length; an increased light output; and an increased lighting efficiency.

13. A method for retrofitting a followspot, the steps comprising:
providing a followspot;
removing one or more covers of a housing of said followspot;
disconnecting one or more first wires inside said housing;
wherein said one or more first wires includes a first negative wire and a first positive wire;
wherein said first negative wire is connected between a negative terminal of a first lamp and a shunt of said housing;
wherein said first positive wire is connected between a positive terminal of said first lamp and an igniter assembly;
removing said first lamp from said housing;
removing a first reflector from said housing;
installing a second lamp into said housing;
wherein said second lamp includes a second reflector;
wherein said second lamp provides a faster focal length; an increased light output; and an increased lighting efficiency;
installing one or more second wires inside said housing;
wherein said one or more second wires includes a second negative wire and a second positive wire;
wherein said second negative wire is connected between said negative terminal of said first lamp and said shunt of said housing;
wherein said second positive wire is connected between said positive terminal of said first lamp and said igniter assembly;
installing said one or more covers of said housing; and
installing a power supply into said followspot;
wherein said power supply provides electrical power to said followspot.

14. The method for retrofitting a followspot in claim 13, wherein said second lamp is a ceramic short arc lamp.

15. The method for retrofitting a followspot in claim 14, wherein said second lamp includes a heat sink;
wherein said heat sink dissipates heat from said second lamp.

16. The method for retrofitting a followspot in claim 15, wherein said second lamp step includes a fan device;
wherein said fan device dissipates heat from said second lamp.

17. The method for retrofitting a followspot in claim 16, wherein said installing second lamp step further comprises the step of:
installing said fan device by connecting said one or more second wires onto said fan device.

18. The method for retrofitting a followspot in claim 17, further comprising the step of:
removing a first heat filter from said housing;
wherein said first heat filter is substantially near said first reflector.

19. The method for retrofitting a followspot in claim 18, wherein said removing said first lamp step further comprises the steps of:
removing a first interlock device; and
installing a second interlock device.

20. A followspot, comprising:
a housing;
a lamp;
a lens; and
a power supply;
wherein said lamp is a ceramic short arc lamp;
wherein said lamp is located substantially inside said housing of a followspot;
wherein said lamp provides a light;
wherein said lamp includes a reflector; a heat filter; and a heat sink;
wherein said reflector reflects said light;
wherein said heat filter is substantially inside of said housing;
wherein said heat filter absorbs radiation from said light;
wherein said heat sink dissipates heat from said lamp;
wherein said lens is located substantially inside said housing;
wherein said lens provides a focus of said light of said followspot;
wherein said power supply provides electrical power to said followspot;
wherein said lamp provides a faster focal length; an increased light output; and
an increased lighting efficiency.
